(19) United States
(12) Patent Application Publication
(10) Pub. No.: US 2025/0261212 A1
(43) Pub. Date: Aug. 14, 2025

(54) TECHNIQUES FOR PREDICTING NETWORK NODE TRANSMISSION CONFIGURATION INDICATOR STATES

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US); Tao LUO, San Diego, CA (US)

(21) Appl. No.: 18/856,366

(22) PCT Filed: Jul. 7, 2022
(86) PCT No.: PCT/CN2022/104397

§ 371 Date: Oct. 11, 2024

(51) Int. Cl. H04W 72/231; H04L 5/00

(52) U.S. Cl. CPC H04W 72/231; H04L 5/0055

(57) ABSTRACT

Various aspects of the present disclosure generally relate to wireless communication. In some aspects. a user equipment (UE) may receive a medium access control (MAC) control element (CE) indication that activates a network node-predicted transmission configuration indicator (TCI) state. The UE may transmit an acknowledgment (ACK) associated with the MAC CE indication. The UE may receive down-link control information (DCI) that indicates the network node-predicted TCI state for a subsequent communication, the DCI scheduling the subsequent communication at a scheduled time that is based at least in part on a threshold amount of time from the ACK or from the MAC CE indication. Numerous other aspects are described.

### FIELD OF THE DISCLOSURE

Aspects of the present disclosure generally relate to wireless communication and to techniques and apparatuses for predicting network node transmission configuration indicator states.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a medium access control (MAC) control element (CE) indication that activates a network node-predicted transmission configuration indicator (TCI) state. The method may include transmitting an acknowledgment (ACK) associated with the MAC CE indication. The method may include receiving downlink control information (DCI) that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to a method of wireless communication performed by a network node. The method may include transmitting, to a UE, a MAC CE indication that activates a network node-predicted TCI state. The method may include receiving an ACK associated with the MAC CE indication. The method may include transmitting DCI that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to a method of wireless communication performed by a UE. The method may include transmitting an indication of support for receiving a DCI-based indication of a network node-predicted TCI state. The method may include receiving the DCI-based indication of the network node-predicted TCI state.

Some aspects described herein relate to a method of wireless communication performed by a base station. The method may include receiving, from a UE, an indication of support for receiving a DCI-based indication of a network node-predicted TCI state. The method may include transmitting the DCI-based indication of the network node-predicted TCI state.

Some aspects described herein relate to a UE for wireless communication. The user equipment may include a memory and one or more processors coupled to the memory. The one or more processors may be configured to receive a MAC CE indication that activates a network node-predicted TCI state. The one or more processors may be configured to transmit an ACK associated with the MAC CE indication. The one or more processors may be configured to receive DCI that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to a network node for wireless communication. The network node may include a memory and one or more processors coupled to the memory. The one or more processors may be configured to transmit, to a UE, a MAC CE indication that activates a network node-predicted TCI state. The one or more processors may be configured to receive an ACK associated with the MAC CE indication. The one or more processors may be configured to transmit DCI that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to a UE for wireless communication. The UE may include a memory and one or more processors coupled to the memory. The one or more processors may be configured to transmit an indication of support for receiving a DCI-based indication of a network node-predicted TCI state. The one or more processors may be configured to receive the DCI-based indication of the network node-predicted TCI state.

Some aspects described herein relate to a base station for wireless communication. The base station may include a memory and one or more processors coupled to the memory. The one or more processors may be configured to receive, from a UE, an indication of support for receiving a DCI-based indication of a network node-predicted TCI state. The one or more processors may be configured to transmit the DCI-based indication of the network node-predicted TCI state.

Some aspects described herein relate to a non-transitory computer-readable medium that stores a set of instructions for wireless communication by a UE. The set of instructions, when executed by one or more processors of the UE, may cause the UE to receive a MAC CE indication that activates a network node-predicted TCI state. The set of instructions, when executed by one or more processors of the UE, may cause the UE to transmit an ACK associated with the MAC CE indication. The set of instructions, when executed by one or more processors of the UE, may cause the UE to receive DCI that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to a non-transitory computer-readable medium that stores a set of instructions for wireless communication by a network node. The set of instructions, when executed by one or more processors of the network node, may cause the network node to transmit, to a UE, a MAC CE indication that activates a network node-predicted TCI state. The set of instructions, when executed by one or more processors of the network node, may cause the network node to receive an ACK associated with the MAC CE indication. The set of instructions, when executed by one or more processors of the network node, may cause the network node to transmit DCI that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to transmit an indication of support for receiving a DCI-based indication of a network node-predicted TCI state. The set of instructions, when executed by one or more processors of the one or more instructions that, when executed by one or more processors of a UE, may cause the one or more instructions that, when executed by one or more processors of a UE to receive the DCI-based indication of the network node-predicted TCI state.

Some aspects described herein relate to a non-transitory computer-readable medium that stores a set of instructions for wireless communication by a base station. The set of instructions, when executed by one or more processors of the base station, may cause the base station to receive, from a UE, an indication of support for receiving a DCI-based indication of a network node-predicted TCI state. The set of instructions, when executed by one or more processors of the base station, may cause the base station to transmit the DCI-based indication of the network node-predicted TCI state.

Some aspects described herein relate to an apparatus for wireless communication. The apparatus may include means for receiving a MAC CE indication that activates a network node-predicted TCI state (e.g., with an indication that the network node-predicted TCI state is network node-predicted). The apparatus may include means for transmitting an ACK associated with the MAC CE indication. The apparatus may include means for receiving DCI that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to an apparatus for wireless communication. The apparatus may include means for transmitting, to a UE, a MAC CE indication that activates a network node-predicted TCI state. The apparatus may include means for receiving an ACK associated with the MAC CE indication. The apparatus may include means for transmitting DCI that indicates the network node-predicted TCI state for a subsequent communication, the DCI scheduling the subsequent communication at a scheduled time that is based at least in part on a threshold amount of time from the ACK or from the MAC CE indication.

Some aspects described herein relate to an apparatus for wireless communication. The apparatus may include means for transmitting an indication of support for receiving a DCI-based indication of a network node-predicted TCI state. The apparatus may include means for receiving the DCI-based indication of the network node-predicted TCI state.

Some aspects described herein relate to an apparatus for wireless communication. The apparatus may include means for receiving, from a UE, an indication of support for receiving a DCI-based indication of a network node-predicted TCI state. The apparatus may include means for transmitting the DCI-based indication of the network node-predicted TCI state.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information reference signal (CSI-RS) beam management procedures, in accordance with the present disclosure.

FIG. 5 is a diagram illustrating an example of predicting transmission configuration indicator (TCI) states, in accordance with the present disclosure.

FIG. 6 is a diagram of an example associated with predicting network node TCI states, in accordance with the present disclosure.

FIG. 7 is a diagram of an example associated with predicting network node TCI states, in accordance with the present disclosure.

FIG. 8 is a diagram of an example associated with predicting network node TCI states, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram illustrating an example process performed, for example, by a UE, in accordance with the present disclosure.

FIG. 12 is a diagram illustrating an example process performed, for example, by a base station, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

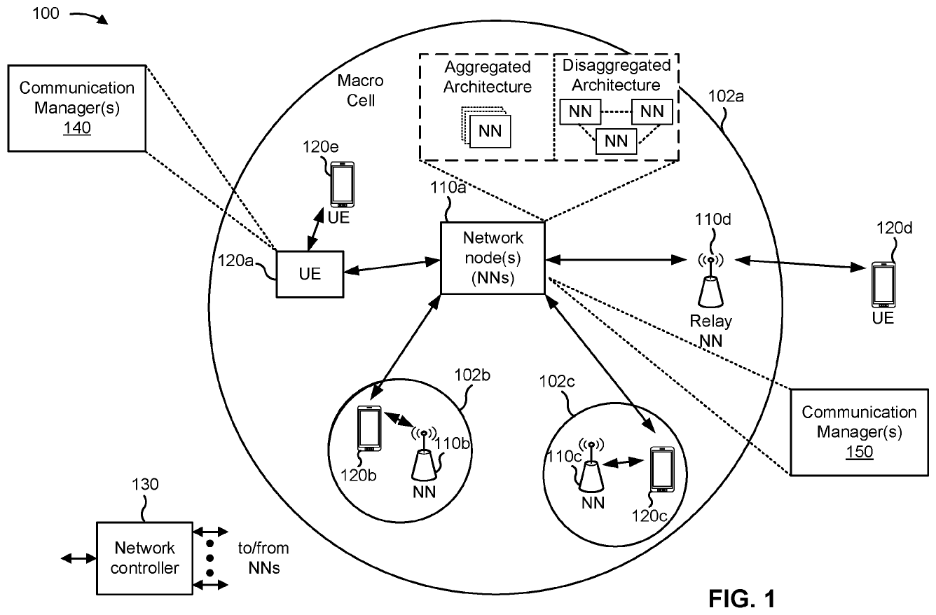

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (FHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a MAC CE indication that activates a network node-predicted transmission configuration indicator (TCI) state; transmit an acknowledgment (ACK) associated with the MAC CE indication; and receive downlink control information (DCI) that indicates the network node-predicted TCI state for a subsequent communication, the DCI scheduling the subsequent communication at a scheduled time that is based at least in part on a threshold amount of time from the ACK or from the MAC CE indication. As described in more detail elsewhere herein, the communication manager 140 may transmit an indication of support for receiving a DCI-based indication of a network node-predicted TCI state; and receive the DCI-based indication of the network node-predicted TCI state. Additionally, or alternatively, the communication manager 140 may perform one or more other operations described herein.

In some aspects, the network node 110 may include a communication manager 150. As described in more detail elsewhere herein, the communication manager 150 may transmit, to a UE, a MAC CE indication that activates a network node-predicted TCI state; receive an ACK associated with the MAC CE indication, and transmit DCI that indicates the network node-predicted TCI state for a subsequent communication, the DCI scheduling the subsequent communication at a scheduled time that is based at least in part on a threshold amount of time from the ACK or from the MAC CE indication. As described in more detail elsewhere herein, the communication manager 150 may receive, from a UE, an indication of support for receiving a DCI-based indication of a network node-predicted TCI state; and transmit the DCI-based indication of the network node-predicted TCI state. Additionally, or alternatively, the communication manager 150 may perform one or more other operations described herein.

As indicated above, FIG. 1 is provided as an example. Other examples may differ from what is described with regard to FIG. 1.

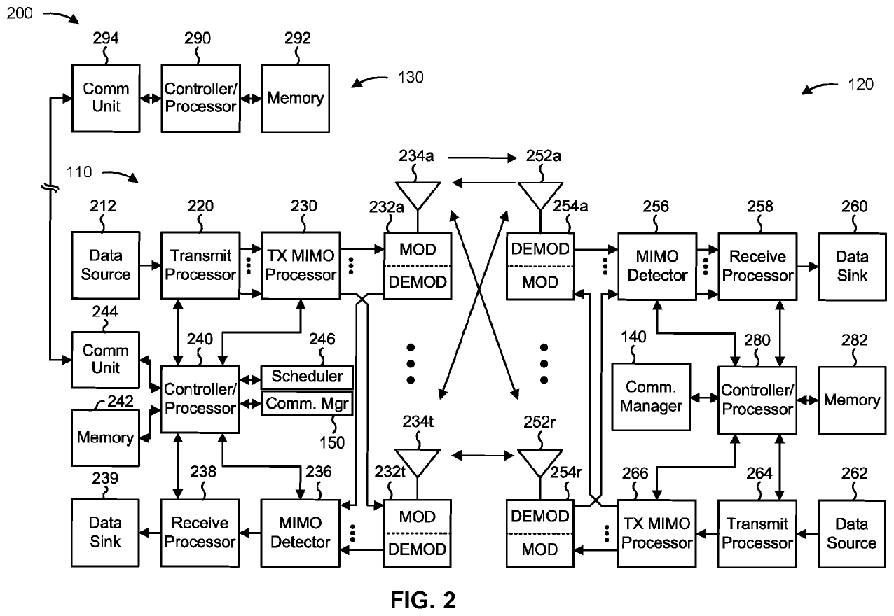

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

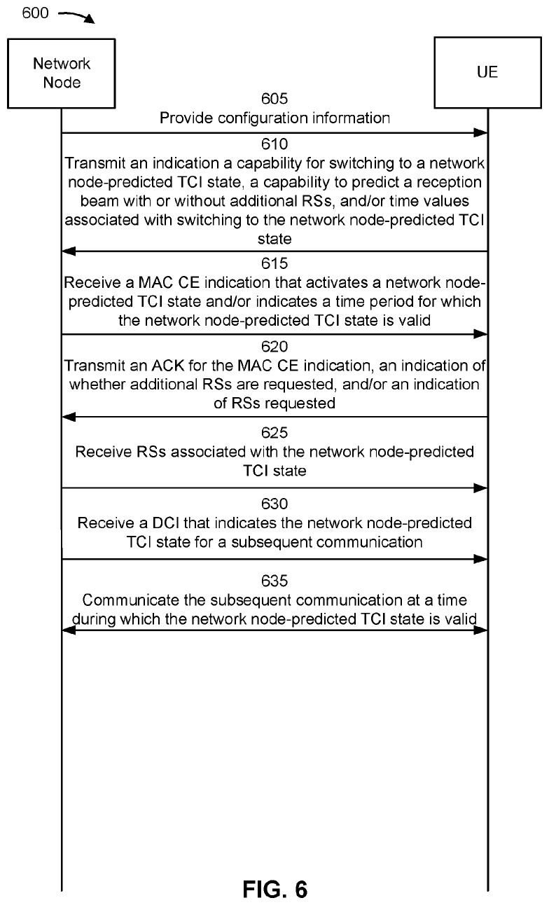

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6-14).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6-14).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

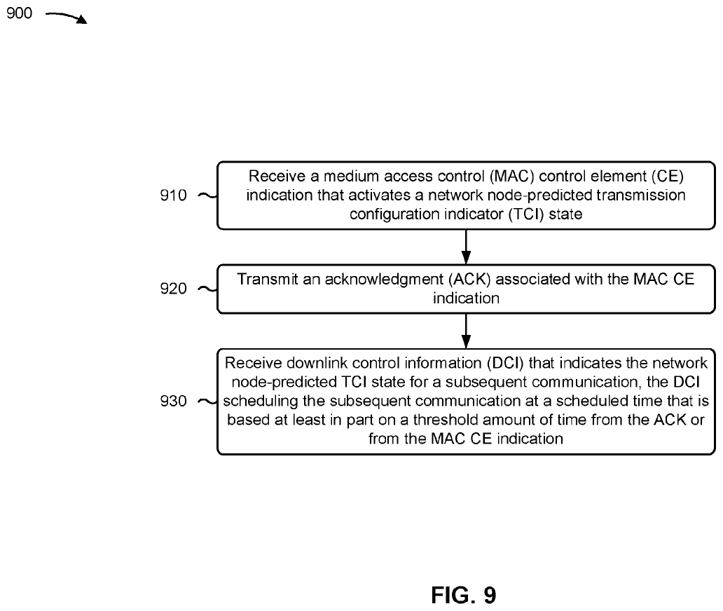

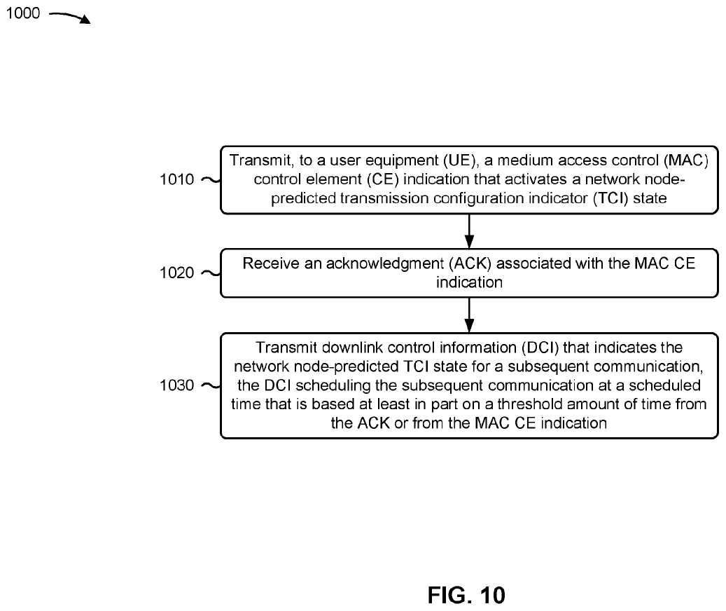

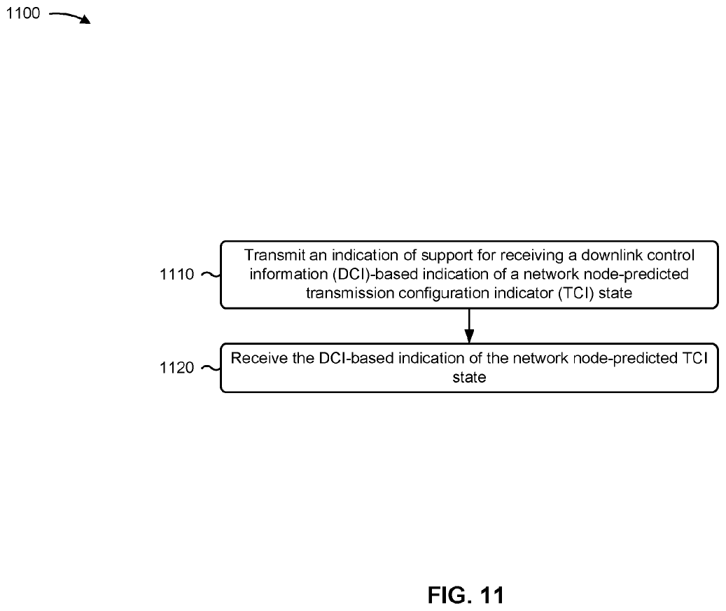

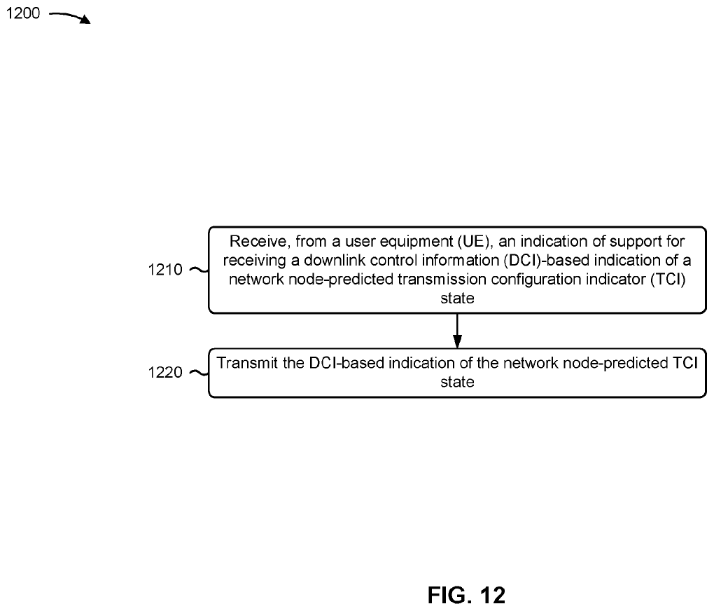

The controller/processor 240 of the network node 110, the controller/processor 280 of the UE 120, or any other component(s) of FIG. 2 may perform one or more techniques associated with predicting network node TCI states, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE includes means for receiving a MAC CE indication that activates a network node-predicted TCI state; means for transmitting an ACK associated with the MAC CE indication; and/or means for receiving DCI that indicates the network node-predicted TCI state for a subsequent communication, the DCI scheduling the subsequent communication at a scheduled time that is based at least in part on a threshold amount of time from the ACK or from the MAC CE indication. In some aspects, the UE includes means for transmitting an indication of support for receiving a DCI-based indication of a network node-predicted TCI state; and/or means for receiving the DCI-based indication of the network node-predicted TCI state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting, to a UE, a MAC CE indication that activates a network node-predicted TCI state; means for receiving an ACK associated with the MAC CE indication; and/or means for transmitting DCI that indicates the network node-predicted TCI state for a subsequent communication, the DCI scheduling the subsequent communication at a scheduled time that is based at least in part on a threshold amount of time from the ACK or from the MAC CE indication. In some aspects, the base station includes means for receiving, from a UE, an indication of support for receiving a DCI-based indication of a network node-predicted TCI state; and/or means for transmitting the DCI-based indication of the network node-predicted TCI state. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

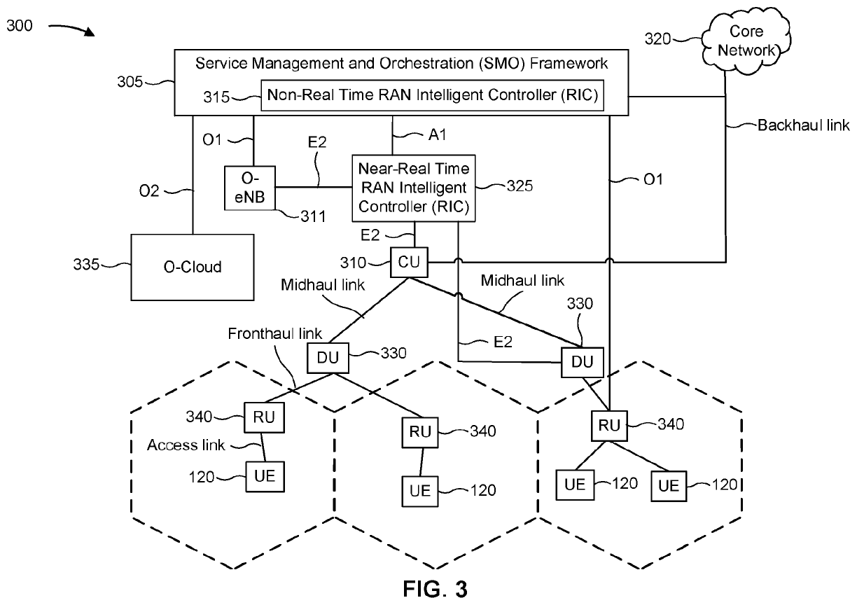

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

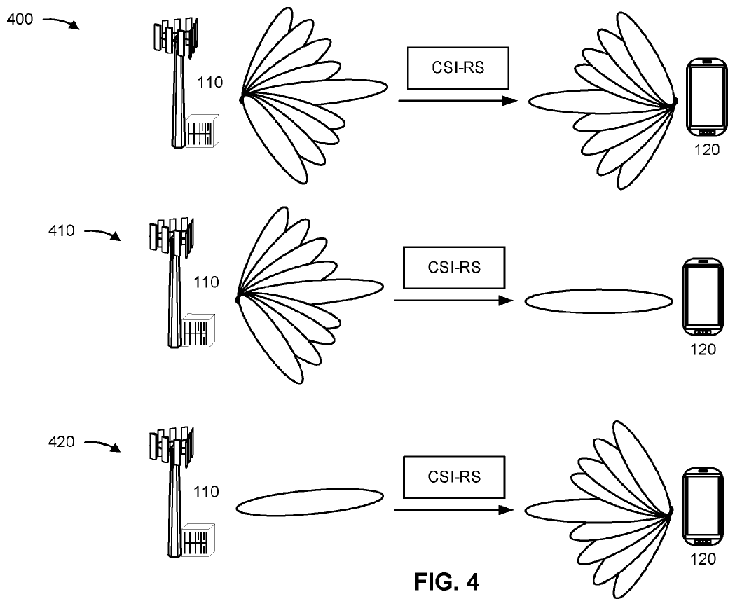

FIG. 4 is a diagram illustrating examples 400, 410, and 420 of channel state information (CSI) reference signal (CSI-RS) beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or a TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management procedure may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management procedure may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RSs at multiple times within the same reference signal resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

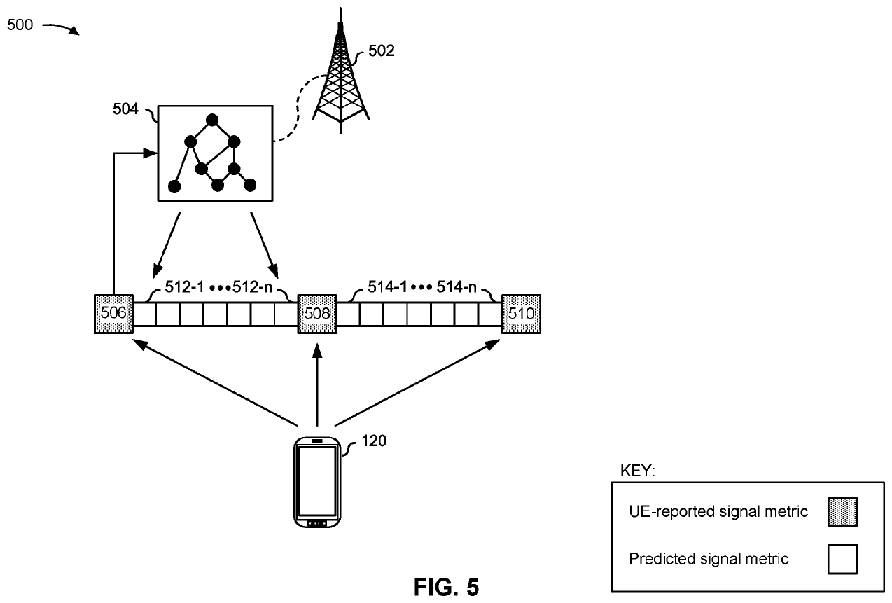

FIG. 5 is a diagram illustrating an example 500 of predicting TCI states, in accordance with the present disclosure.

Beam management procedures may improve communications in a wireless network by providing a network node and/or a UE with a mechanism to identify beams with better signal quality relative to other beams. Communicating via the wireless network using beams with better signal quality may reduce recovery errors at a receiver, increase data throughput, and/or reduce data-transfer latencies (e.g., by reducing retransmissions) relative to the other beams. Various factors may cause the network node and UE to perform the beam management procedures multiple times, such as atmospheric changes, the UE moving to a new location, and/or changes in interference associated with other devices. The repeated beam management procedures may consume air interface resources (e.g., frequency resources and/or time resources) that the wireless network could otherwise direct to additional devices or use for other transmissions. Thus, the repeated beam management procedures may increase data-transfer latencies for other devices while the network node and the UE perform each beam management procedure.

To reduce signaling overhead and resource consumption associated with beam management procedures, a network node 502 (shown in the example 500 as a base station) may select a beam and/or beam pairs, associated with TCI states, based at least in part on prediction algorithms. For example, the network node 502 may include one or more modules 504 that are trained using a machine learning algorithm (e.g., a deep neural network (DNN) algorithm, a long short-term memory (LSTM) network algorithm, a gradient boosted algorithm, a K-means algorithm, and/or a random forest algorithm). Machine learning involves computers learning from data to perform tasks. As one example, machine learning algorithms are used to train machine learning models based at least in part on sample data, known as “training data.” Once trained, machine learning models may be used to make predictions, decisions, or classifications relating to new observations. In some aspects, the module(s) 504 may be trained to predict a signal metric (e.g., a signal-to-interference-plus-noise ratio (SINR) metric and/or an RSRP metric). Alternatively or additionally, the module(s) 504 may be trained to predict a TCI state, beam, and/or beam pair (e.g., associated with a pair of TCI states or a TCI state an spatial relation, among other examples) based at least in part on a signal metric (e.g., a UE-generated signal metric and/or a predicted signal metric).

To illustrate, the network node 502 may periodically receive a UE-reported signal metric (e.g., from the UE 120), as shown by reference number 506, reference number 508, and reference number 510. As one example, the network node 502 may receive, as a UE-reported signal metric, a layer 1 RSRP (L1-RSRP) metric and/or a layer 1 SINR (L1-SINR) metric from the UE 120 every 120 milliseconds (msec). The module(s) 504 may receive the UE-reported signal metric as input, and predict one or more signal metrics and/or one or more TCI states at various points in time as shown by reference number 512-1 to reference number 512-n (where n is an integer). For instance, the module(s) 504 may use the UE-reported signal metric shown by reference number 506 to predict a set of future signal metrics and/or a TCI states at a periodicity of 20 msec. The module(s) 504 may iteratively receive UE-reported signal metrics as shown by reference number 508 and reference number 510 as feedback for subsequent predictions. To illustrate, the module(s) 504 may use the UE-reported signal metric shown by reference number 508 and/or the UE-reported signal metric shown by reference number 506 to predict signal metrics as shown by reference number 514-1 to reference number 514-n. The module(s) 504 may alternatively or additionally select a TCI state and/or beam pair that is predicted to have better performance (e.g., improved signal quality, reduced recovery errors, and/or increased data throughput) relative to other beams and/or TCI states. To preserve air interface resources, the UE 120 may be configured to refrain from reporting a signal metric in between the configured reporting periods, as shown by reference number 506, reference number 508, and reference number 510.

As indicated above, FIG. 5 is provided as an example. Other examples may differ from what is described with regard to FIG. 5.

In some networks, a network node may provide assistance information for a UE to identify a predicted network node transmission beam and/or an associated TCI state (e.g., for better refinement of UE reception (RX) beam). In some networks, a TCI indication and/or activation window may be reduced for future transmission beam sweeping. For example, the network node may indicate and/or activate a future TCI state associated with a reference signal (RS) for receiving a scheduled physical downlink shared channel (PDSCH) communication from pre-configured future TCI states that are output from an AI model. However, without synchronization between the network node and the UE of a window for when the network node-predicted TCI state is valid, the network node may attempt to transmit a subsequent communication before the UE is capable to receive the subsequent communication, which may result in communication errors that consume power, computing, network, and/or power resources to detect and correct. Alternatively, the network node may wait an unnecessarily long amount of time to transmit a subsequent communication when the UE is already prepared to receive the subsequent communication, which may result in increased latency of communications.

In some aspects described herein, a UE my receive a MAC CE indication that activates a network node-predicted TCI state. The UE may transmit an ACK associated with the MAC CE indication and may receive DCI that indicates the network node-predicted TCI state for a subsequent communication. The DCI may schedule the subsequent communication at a scheduled time that is based at least in part on a threshold amount of time from the ACK or from the MAC CE indication (e.g., a switching time). Additionally, or alternatively, the DCI may schedule the subsequent communication at the scheduled time that is within (e.g., inclusive or exclusive of) an additional threshold amount of time from the ACK or from the MAC CE indication.

In an example, upon receiving a MAC CE activating a TCI-state as a network node-predicted TCI state (e.g., a network node-predicted future TCI-state), with a TypeD-QCL source RS that is at least a CSI-RS or an SSB, the UE may apply a corresponding timeline rule for scheduling and/or receiving a subsequent communication via the network node-predicted TCI state. For example, the UE may not expect to be scheduled with a PDSCH using the network node-predicted TCI state, for a first duration of X slots after a slot during which the UE transmits an ACK for the MAC CE. Provided that the UE sends out an ACK for the MAC CE in slot n, the UE may expect to be scheduled with a PDSCH using the network node-predicted TCI state during a second duration Y that starts from slot n+X+1 until slot n+X+Y. In some aspects, a value of X may be reduced if the UE is aware that the TCI state is a network node-predicted TCI state.

In some aspects, this scheme may be applied based at least in part on the network node-predicted TCI state not being in a the previous active TCI state list (e.g., indicated in a previous MAC CE) before the UE received the activation MAC CE.

In some aspects, the scheme may reuse or extend parameters for an unknown TCI-state switching latency timeline. For example, if the network node-predicted TCI state is considered to be unknown (e.g., based on definitions in a communication protocol), such that unknown TCI state switching latency can be reused or may be used as a basis from which the value of X may be indicated. In an example, the UE may not have identified a proper reception beam for associated downlink RSs, and the UE may need additional time to complete reception beam refinement. However, the duration of X-slots may be shorter than the latency regarding unknown TCI states if the UE has reported a capability for reception beam prediction.

In some aspects, the UE may report a capability for values of X. For example, a minimum value of X may be reported by the UE as a capability for instances where the network node-predicted TCI state is considered to be unknown. If the UE is additionally equipped with an AI/ML-based reception beam predictor (e.g., input could be other DL-RSs, associated L1-RSRPs, and associated reception beams), although the UE may have not measured the DL-RS of the indicated network node-predicted TCI state, the reception beam may be predicted by the UE and the minimum duration of X may be reduced (e.g., reduced to 3 msec for known TCI-states).

In some aspects, the UE may receive indications of values of X and/or Y via an activation MAC CE that activated the network node-predicted TCI state. For example, the MAC CE may indicate the values of X and/or Y for each network node-predicted TCI state activated by the MAC CE. This scheme may be based at least in part on indicating an index of RRC-configured values of X and/or Y.

In some aspects, upon receiving a MAC CE activating at least one TCI-state that is a network node-predicted TCI state (e.g., a “network node predicted future TCI-state”), the UE may perform measurements and/or reporting of measurements of RSs within the first duration of time of X or may not measure RSs within the first duration of time of X. In a first example, based at least in part on the UE being capable of predicting reception beams without further RS measurements, or based at least in part on the UE already identifying one or more proper reception beams during a previous beam measurement for the network node-predicted TCI state, the UE may not expect additional transmission of DL-RSs associated with the network node-predicted TCI state or DL-RSs that are Type D quasi-co-located (QCL) with the DL-RSs associated with the network node-predicted TCI state. In some aspects, the UE may not expect to receive the network node-predicted TCI state during the first duration based at least in part on an implicit agreement between the network node and the UE with no additional signaling to indicate the agreement. The implicit agreement may be based at least in part on the UE reporting to the network node of a capability of predicting reception beams without additional DL-RS measurement. Additionally, or alternatively, the implicit agreement may be based at least in part on the DL-RS including a periodic (P) or semi-persistent (SP) channel measurement resource (CMR) set transmitted to the UE.

In some aspects, the UE may not expect to receive the network node-predicted TCI state during the first duration based at least in part on an explicit indication by the UE of whether such additional DL-RSs is requested during the first duration. The UE may transmit the explicit indication after receiving the MAC CE. For example, the UE may be expected to report a 2-bit ACK associated with a PDSCH carrying the TCI-state activation MAC CE A bit (e.g., the 2nd bit) may indicate whether such additional DL-RS is requested during the first duration. In some aspects, the UE may expect at most one network node-predicted TCI state being activated by each MAC CE, and the explicit indication may indicate a request for additional DI-RSs for the, at most, one network node-predicted TCI state. In some aspects, the UE reports “no request” if all network node-predicted TCI states activated by the MAC CE do not need additional DL-RSs; otherwise, the UE reports a request for additional DL-RSs.

In some aspects, the UE is not capable of predicting reception beams when the UE has not identified proper reception beams during previous beam measurements for the network node-predicted TCI state. In some aspects, the UE expects transmission of additional DL-RSs associated with the TCI state (or DL-RSs that are TypeD-QCL with the DL-RSs of the TCI-state) during the first duration. In some aspects, the UE may expect transmission of the additional DL-RSs based at least in part on an implicit agreement between the network node and the UE based at least in part no additional signaling. For example, this may be based at least in part on the UE failing to report to the network node that the UE supports reception beam prediction (e.g., an explicit indication of a lack of support or a lack of indication of support). In some aspects, this scheme may be based at least in part on the TCI state being considered as unknown. In some aspects, types and/or configurations of the additional DL-RSs may be determined based at least in part on types and/or configurations of RSs designated for unknown TCI states in a communication protocol.

In some aspects, the UE may expect transmission of the additional DL-RSs based at least in part on an explicit indication transmitted to the network node by the UE indicating whether additional DL-RSs is requested during the first duration. The UE may transmit the explicit indication after receiving the TCI state activation MAC CE. For example, the UE may be expected to report a 2-bit ACK associated with a PDSCH carrying the TCI-state activation MAC CE. A bit (e.g., the second bit) may indicate whether additional DL-RSs are requested during the first duration. In some aspects, the UE may expect at most one network node-predicted TCI state being activated by each MAC CE, and the explicit indication may indicate a request for additional DL-RSs for the at most one network node-predicted TCI state. In some aspects, the UE reports “no request” if all network node-predicted TCI states activated by the MAC CE do not need additional DL-RSs, otherwise the UE reports a request for additional DL-RSs.

In some aspects, the UE is capable of predicting reception beams, but still requires reduced number of additional DL-RSs for the network node-predicted TCI state. In some aspects, the UE may expect transmission of additional DL-RSs associated with the TCI state (or DL-RS TypeD-QCL with the DL-RS associated with TCI state) during the first duration based at least in part on an implicitly agreed between the gNB and the UE, based on no additional signaling (e.g., based at least in part on a reported capability of predicting reception beams, wherein the prediction still requests certain amount of DL-RS measurements). In some aspects, the capability may indicate a number of CSI-RS resources for a repetition on CSI-RS resource set requested for reception beam prediction for network node-predicted TCI state. In some aspects, the capability may indicate a number of P or SP CSI-RS or SSB occasions requested for reception beam prediction for network node-predicted TCI states.

In some aspects, the UE may transmit an explicit indication of whether additional DL-RSs are requested during the first duration (e.g., after receiving the TCI state activation MAC CE). For example, the UE may be expected to report a 2-bit ACK associated with the PDSCH carrying the TCI state activation MAC CE. A bit (e.g., the second bit) may indicate whether additional DL-RSs are requested during the first duration. In some aspects, the UE may expect at most one network node-predicted TCI state being activated by each MAC CE, and the explicit indication may indicate a request for additional DL-RSs for the at most one network node-predicted TCI state. In some aspects, the UE reports “no request” if all network node-predicted TCI states activated by the MAC CE do not need additional DL-RSs, otherwise the UE reports a request for additional DL-RSs. If the 2nd bit indicates a request for the DL-RSs, the UE may expect to be triggered or activated with an SP or aperiodic (AP) CSI report to report parameters for the DL-RSs. In some aspects, the UE may expect to report parameters for the DL-RSs via a MAC CE if the UE has been scheduled with an uplink grant. If the UE has not been scheduled with an uplink grant, the explicit indication may be an implicit scheduling request for reporting the parameters for the DL-RS parameters. In some aspects, the DL-RS parameters include a number of CSI-RS resources for a repetition on CSI-RS resource set requested for reception beam prediction for network node-predicted TCI states. In some aspects, the DL-RS parameters include a number P or SP CSI-RS or SSB occasions requested for reception beam prediction, for network node-predicted TCI states (e.g., “future TCI-states”).

In some aspects, the UE may support DCI-based indications of network node-predicted TCI states. In some aspects, a timeline for using DCI-based network node-predicted TCI states may be based at least in part on one or more parameters, a configuration of the UE, a reported capability of the UE, and/or a communication protocol.

In an example, the UE may report a time domain duration threshold (timeDurationForQCL_Predicted) for determining a reception spatial filter, with the time domain duration threshold associated with a network node-predicted TCI state indicated by a DL-grant DCI for scheduling a PDSCH. For example, if the indicated TCI state is unknown but it has been identified as a network node-predicted TCI-state, when the UE is configured with a higher layer parameter tci-PresentInDCI that is enabled for a control resource set (CORESET) used to schedule the PDSCH at slot n, the UE may support reception of the PDSCH after a particular time. For example, the UE may support reception of the PDSCH associated with the network node-predicted TCI state (e.g., of a serving cell on which a TCI state switch occurs) at a first slot that is after slot n+time DurationForQCL_Predicted (e.g., a value of X), where timeDurationForQCL_Predicted is a UE reported capability of the time domain duration threshold for physical downlink control channel (PDCCH) processing, calculating and/or predicting the reception beam associated with the network node-predicted TCI state, and applying spatial QCL information of the network node-predicted TCI-state.

In some aspects, the UE may expect that a time offset between the DCI that indicates the network node-predicted TCI state and the first symbol of the PDSCH scheduled by the DL-grant DCI is greater than or equal to timeDurationForQCL_Predicted, where timeDurationForQCL Predicted is a UE reported capability on a time duration threshold for calculating and/or predicting a reception beam associated with the network node-predicted TCI state (e.g., a “gNB predicted future TCI-state”).

In some networks, the UE may report a single capability time DurationForQCL that defines a minimum number of OFDM symbols required by the UE to perform PDCCH reception and to apply spatial QCL information received in DCI for PDSCH processing. The UE may indicate one value of the minimum number of OFDM symbols per each subcarrier spacing of 60 kHz and 120 kHz. In some aspects, the UE shall report another similar capability that is dedicated for only network node-predicted TCI states indicated by DL-grant DCI (e.g., the UE may also use an ML-model to predict a reception beam without actual reception beam sweeping and/or measurements).

Based at least in part on using one or more of the techniques and/or configurations described herein, the UE and the network node may apply a duration of time (e.g., X) after receiving an indication to use a network node-predicted TCI state, during which the UE does not support receiving a communication via the network node-predicted TCI state. The duration may be configured based at least in part on a capability of the UE, which may conserve power, computing, network, and/or communication resources to detect and correct a transmission of a communication before the UE is capable to receive the subsequent communication. Alternatively, configuring the duration based at least in part on the capability of the UE may reduce latency that may have otherwise been caused by the network node waiting an unnecessarily long amount of time to transmit the communication when the UE is already prepared to receive the communication. Additionally, or alternatively, based at least in part on synchronizing a communication of RSs for the UE to obtain a UE reception beam associated with the network node-predicted TCI state, the UE and the network node may reduce communication errors that may have otherwise consumed power, computing, network, and/or power resources to detect and correct.

FIG. 6 is a diagram of an example 600 associated with predicting network node TCI states, in accordance with the present disclosure. As shown in FIG. 6, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 6.

As shown by reference number 605, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit capability information associated with switching to a network node-predicted TCI state, predicting a reception beam with or without RSs, and/or time values associated with switching to the network node-predicted TCI state.

The UE may configure itself based at least in part on the configuration information. In some aspects, the UE may be configured to perform one or more operations described herein based at least in part on the configuration information.

As shown by reference number 610, the UE may transmit, and the network node may receive, a capabilities report. In some aspects, the capabilities report may indicate capabilities associated with switching to a network node-predicted TCI state, predicting a reception beam with or without additional RSs, and/or time values associated with switching to the network node-predicted TCI state, among other examples.

As shown by reference number 615, the UE may receive, and the network node may transmit, a MAC CE indication that activates a network node-predicted TCI state and/or indicates a time period for which the network node-predicted TCI state is valid. In some aspects, the network node-predicted TCI state may have been unknown and/or may have not been an active TCI state prior to reception of the MAC CE indication. In some aspects, the MAC CE may indicate the network node-predicted TCI state is network node-predicted.

As shown by reference number 620, the UE may transmit, and the network node may receive, an ACK for the MAC CE indication, an indication of whether additional RSs are requested, and/or an indication of RSs requested. In some aspects, the ACK may include an indication (e.g., a single-bit indication) of whether additional RSs are requested. In some aspects, the indication of whether additional RSs are requested is associated with a single network node-predicted TCI state activated by the MAC CE. In some aspects, the indication of whether additional RSs are requested is associated with all network node-predicted TCI states activated by the MAC CE

As shown by reference number 625, the UE may receive, and the network node may transmit, RSs associated with the network node-predicted TCI state. In some aspects, the UE may receive the RSs based at least in part on an indication of a resource for receiving the RSs. For example, the network node may transmit the indication of the resources based at least in part on receiving the ACK.

In some aspects, the UE may receive a standard number of RSs (e.g., associated with unknown TCI states) or a reduced number of RSs. The number of RSs may be explicitly indicated by the UE after receiving the MAC CE or may be based at least in part on a previously indicated capability of the UE, among other examples. For example, the number of RSs may be reduced based at least in part on a reported capability of the UE to perform beam prediction for a UE reception beam. In some aspects, a number of RSs may be based at least in part on the network node-predicted TCI state being an unknown TCI state (e.g., not configured via RRC signaling for activation and/or not activated via a previous MAC CE).

In some aspects, the UE may not receive any RSs. For example, the UE may receive no RSs between reception of the MAC CE indication and reception of a DCI that scheduled a subsequent communication using the network node-predicted TCI state. The UE may receive no RSs based at least in part on an explicit indication that no RSs are requested (e.g., within the ACK described in connection with reference number 620) and/or based at least in part on a reported capability of the UE (e.g., associated with UE-prediction of a UE reception beam without RSs).

As shown by reference number 630, the UE may receive, and the network node may transmit, a DCI that indicates the network node-predicted TCI state for a subsequent communication. In some aspects, the DCI may schedule the subsequent communication at a scheduled time that is based at least in part on a threshold amount of time from the ACK or from the MAC CE indication.

In some aspects, the threshold amount of time (e.g., a minimum time and/or X) is based at least in part on an unknown TCI state switching latency, a UE capability for reception beam prediction, an indication by the UE of the threshold amount of time, or an indication (e.g., within the MAC CE indication) of the threshold amount of time.

In some aspects, the DCI schedules the subsequent communication at the scheduled time that is further based at least in part on being within an additional threshold amount of time (e.g., X+Y) from the ACK or from the MAC CE indication. In some aspects, the first threshold amount of time and/or the second threshold amount of time is based at least in part on an unknown TCI state switching latency, a UE capability for reception beam prediction, an indication by the UE of one or more of the first threshold amount of time or the second threshold amount of time, and/or an indication, within the MAC CE indication, of one or more of the first threshold amount of time or the second threshold amount of time, among other examples.

As shown by reference number 635, the UE and the network node may communicate the subsequent communication at a time during which the network node-predicted TCI state is valid For example, the network node-predicted TCI state may be valid based at least in part on the time being between a first threshold amount of time and a second threshold amount of time from reception of the MAC CE or from transmission of the ACK.

In some aspects, the UE may receive the subsequent communication without receiving reference signals associated with the network node-predicted TCI state between a first time of receiving the MAC CE indication and a second time of receiving the subsequent communication. In some aspects, reception of the subsequent communication without receiving reference signals associated with the network node-predicted TCI state between the first time of receiving the MAC CE indication and the second time of receiving the subsequent communication is based at least in part on an indication, by the UE, of support for predicting reception beams without additional reference signal measurement, downlink reference signals associated with the network node-predicted TCI state being associated with periodic or semi-persistent channel measurement resources, and/or an indication, by the UE, and within feedback associated with the MAC CE, that the reference signals are not requested, among other examples. In some aspects, the indication within the feedback associated with the MAC CE is associated with the network node-predicted TCI state based at least in part on the network node-predicted TCI state being an only network node-predicted TCI state indicated in the MAC CE indication or based at least in part on the indication within the feedback associated with the MAC CE being associated with all network node-predicted TCI states indicated in the MAC CE indication.

Based at least in part on using one or more of the techniques and/or configurations described herein, the UE and the network node may apply a duration of time (e.g., X) after receiving an indication to use a network node-predicted TCI state, during which the UE does not support receiving a communication via the network node-predicted TCI state. The duration may be configured based at least in part on a capability of the UE, which may conserve power, computing, network, and/or power resources to detect and correct a transmission of a communication before the UE is capable to receive the subsequent communication. Alternatively, the configuring the duration based at least in part on the capability of the UE may reduce latency that may have otherwise been caused by the network node waiting an unnecessarily long amount of time to transmit the communication when the UE is already prepared to receive the communication. Additionally, or alternatively, based at least in part on synchronizing on communication of RSs for the UE to obtain a UE reception beam associated with the network node-predicted TCI state, the UE and the network node may reduce communication errors that may have otherwise consumed power, computing, network, and/or power resources to detect and correct.

As indicated above, FIG. 6 is provided as an example. Other examples may differ from what is described with respect to FIG. 6.

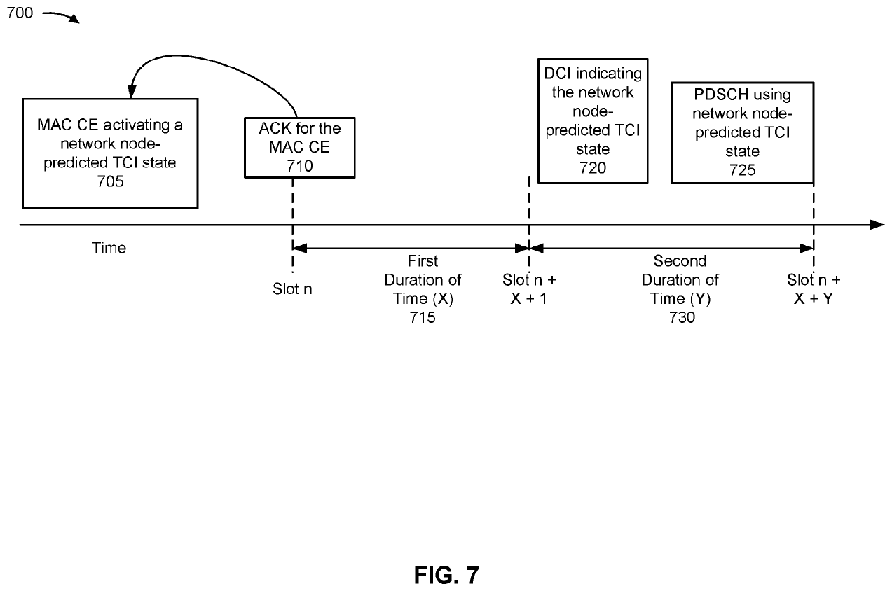

FIG. 7 is a diagram of an example 700 associated with predicting network node TCI states, in accordance with the present disclosure. In context of FIG. 7, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 7.

As shown in FIG. 7, the UE may receive a MAC CE activating a network node-predicted TCI state 705. In some aspects, the network node-predicted TCI state may be an unknown TCI state (e.g., the UE does not have valid RS measurements).

The UE may transmit an ACK for the MAC CE 710 during a slot n. As described herein, the ACK may indicate a request for RSs or may decline RSs for using the network node-predicted TCI state. During a first duration of time (X) 715 extending to a slot n+X+1, the UE does not expect to receive a communication using the network node-predicted TCI. In some aspects, the UE may receive RSs for the network node-predicted TCI during the first duration of time (X) 715 for the UE to measure and obtain a UE reception beam for communicating via the network node-predicted TCI.

After the first duration of time (X) 715, the UE may receive a DCI indicating the network node-predicted TCI state 720 for transmission of a subsequent communication. The UE may receive a PDSCH communication using the network node-predicted TCI 725 during a second duration of time (Y) 730 that extends from the first duration of time (X) 715. In some aspects, the UE may be configured to receive the DCI and/or the PDSCH communication via the network node-predicted TCI state only within the second duration of time (Y) 730.

As indicated above, FIG. 7 is provided as an example. Other examples may differ from what is described with respect to FIG. 7.

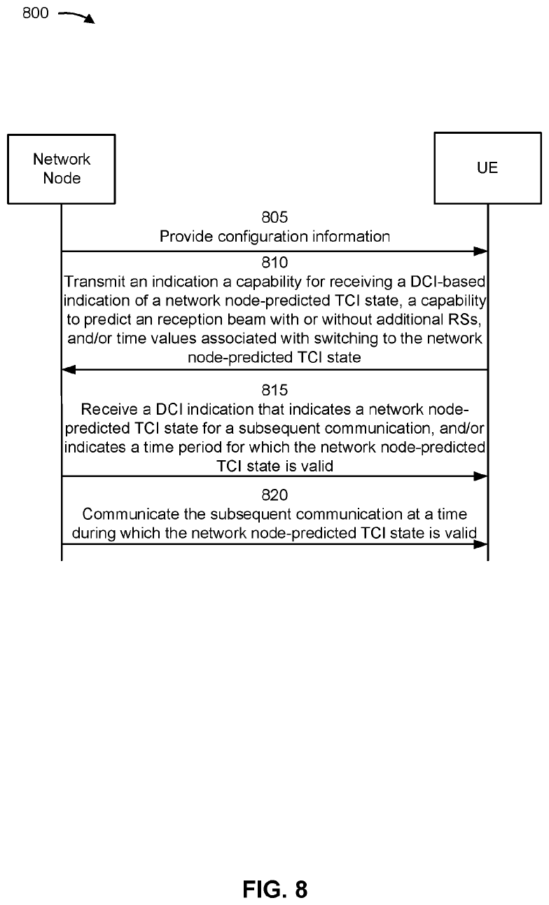

FIG. 8 is a diagram of an example 800 associated with predicting network node TCI states, in accordance with the present disclosure. As shown in FIG. 8, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 8.

As shown by reference number 805, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit capability information associated with receiving a DCI-based indication of a network node-predicted TCI state, predicting a reception beam with or without additional RSs, and/or time values associated with switching to the network node-predicted TCI state. In some aspects, the configuration information enables DCI-based indications of network node-predicted TCI states.

The UE may configure itself based at least in part on the configuration information. In some aspects, the UE may be configured to perform one or more operations described herein based at least in part on the configuration information.

As shown by reference number 810, the UE may transmit, and the network node may receive, a capabilities report. In some aspects, the capabilities report may indicate capabilities associated with receiving a DCI-based indication of a network node-predicted TCI state, predicting a reception beam with or without additional RSs, and/or time values associated with switching to the network node-predicted TCI state, among other examples. In some aspects, the UE may transmit an indication of support for receiving a DCI-based indication of a network node-predicted TCI state and/or one or more parameters associated with the support (e.g., limits on the support). For example, the UE may indicate a threshold amount of time (e.g., a minimum time) between reception of the DCI-based indication and reception of a communication via the network node-predicted TCI state. In some aspects, the threshold amount of time is based at least in part on a capability of the UE for configuring a reception beam for the network node-predicted TCI state. In some aspects, the threshold amount of time is a subcarrier spacing associated with the communication or whether the network node-predicted TCI state is unknown, among other examples.

As shown by reference number 815, the UE may receive a DCI indication that indicates a network node-predicted TCI state for a subsequent communication, and/or indicates a time period for which the network node-predicted TCI state is valid. In some aspects, the time period may be valid based at least in part on being after a first threshold amount of time (e.g., X) and/or before a second threshold amount of time (e.g., X+Y).

In some aspects, the UE may receive, within the DCI or outside of the DCI, an indication that unknown TCI states are network node-predicted TCI states and/or that the network node-predicted TCI state is network node-predicted. For example, the UE may receive RRC signaling (e.g., associated with configuring TCI states for activation), MAC signaling (e.g., associated with activating configured TCI states), or within the DCI that the network node-predicted is network node-predicted. In some aspects, the MAC CE is configured for activating only network node-predicted TCI states (e.g., a dedicated MAC CE for network node-predicted TCI states).

As shown by reference number 820, the UE and the network node may communicate the subsequent communication at a time during which the network node-predicted TCI state is valid. In some aspects, the time during which the network node-predicted TCI state is valid is based at least in part on a first threshold amount of time (e.g., a minimum time) and/or a second threshold amount of time (e.g., a maximum time). In some aspects, the UE and the network node may continue using the network node-predicted TCI after the time, based at least in part on performing additional beam management.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with techniques for predicting network node TCI states.

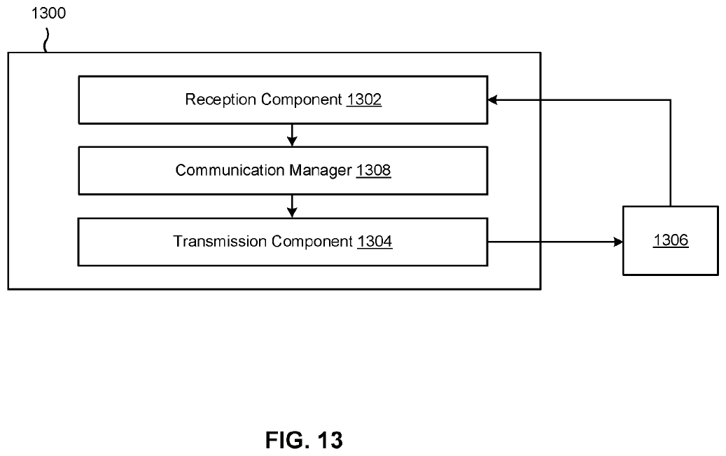

As shown in FIG. 9, in some aspects, process 900 may include receiving a MAC CE indication that activates a network node-predicted TCI state (block 910). For example, the UE (e.g., using communication manager 140 and/or reception component 1302, depicted in FIG. 13) may receive a MAC CE indication that activates a network node-predicted TCI state, as described above.

As further shown in FIG. 9, in some aspects, process 900 may include transmitting an ACK associated with the MAC CE indication (block 920). For example, the UE (e.g., using communication manager 140 and/or transmission component 1304, depicted in FIG. 13) may transmit an ACK associated with the MAC CE indication, as described above.

As further shown in FIG. 9, in some aspects, process 900 may include receiving DCI that indicates the network node-predicted TCI state for a subsequent communication, the DCI scheduling the subsequent communication at a scheduled time that is based at least in part on a threshold amount of time from the ACK or from the MAC CE indication (block 930). For example, the UE (e.g., using communication manager 140 and/or reception component 13, depicted in FIG. 13) may receive DCI that indicates the network node-predicted TCI state for a subsequent communication, the DCI scheduling the subsequent communication at a scheduled time that is based at least in part on a threshold amount of time from the ACK or from the MAC CE indication, as described above.

Process 900 may include additional aspects, such as any single aspect or any combination of aspects described below and/or in connection with one or more other processes described elsewhere herein.

In a first aspect, process 900 includes transmitting, during a time period, an ACK associated with the MAC CE indication, wherein the DCI schedules the subsequent communication at a time that is based at least in part on a threshold amount of time from the time period, or wherein the DCI schedules the subsequent communication at a time that is based at least in part on the threshold amount of time from the MAC CE indication.

In a second aspect, alone or in combination with the first aspect, the threshold amount of time is based at least in part on one or more of an unknown TCI state switching latency, a UE capability for reception beam prediction, an indication, by the UE, of the threshold amount of time, or an indication, within the MAC CE indication, of the threshold amount of time.

In a third aspect, alone or in combination with one or more of the first and second aspects, the DCI schedules the subsequent communication at the scheduled time that is further based at least in part on being within an additional threshold amount of time from the ACK or from the MAC CE indication.

In a fourth aspect, alone or in combination with one or more of the first through third aspects, one or more of the first threshold amount of time or the second threshold amount of time is based at least in part on one or more of an unknown TCI state switching latency, a UE capability for reception beam prediction, an indication, by the UE, of one or more of the first threshold amount of time or the second threshold amount of time, or an indication, within the MAC CE indication, of one or more of the first threshold amount of time or the second threshold amount of time.

In a fifth aspect, alone or in combination with one or more of the first through fourth aspects, prior to reception of the MAC CE indication, the network node-predicted TCI state was not an active TCI state.

In a sixth aspect, alone or in combination with one or more of the first through fifth aspects, process 900 includes receiving the subsequent communication without receiving reference signals associated with the network node-predicted TCI state between a first time of receiving the MAC CE indication and a second time of receiving the subsequent communication.

In a seventh aspect, alone or in combination with one or more of the first through sixth aspects, reception of the subsequent communication without receiving reference signals associated with the network node-predicted TCI state between the first time of receiving the MAC CE indication and the second time of receiving the subsequent communication is based at least in part on one or more of an indication, by the UE, of support for predicting reception beams without additional reference signal measurement, downlinking reference signals associated with the network node-predicted TCI state being associated with periodic or semi-persistent channel measurement resources, or an indication, by the UE and within feedback associated with the MAC CE, that the reference signals are not requested.

In an eighth aspect, alone or in combination with one or more of the first through seventh aspects, the indication within the feedback associated with the MAC CE is associated with the network node-predicted TCI state based at least in part on the network node-predicted TCI state being an only network node-predicted TCI state indicated in the MAC CE indication, or the indication within the feedback associated with the MAC CE being associated with all network node-predicted TCI state indicated in the MAC CE indication.

In a ninth aspect, alone or in combination with one or more of the first through eighth aspects, process 900 includes receiving the subsequent communication after receiving reference signals associated with the network node-predicted TCI state between a first time of receiving the MAC CE indication and a second time of receiving the subsequent communication.

In a tenth aspect, alone or in combination with one or more of the first through ninth aspects, reception of the subsequent communication after receiving reference signals associated with the network node-predicted TCI state between the first time of receiving the MAC CE indication and the second time of receiving the subsequent communication is based at least in part on one or more of an indication, by the UE, of a request for reference signal measurement, a failure to indicate, by the UE, that the UE supports predicting reception beams without reference signal measurement, or the network node-predicted TCI state being an unknown TCI state.

In an eleventh aspect, alone or in combination with one or more of the first through tenth aspects, a number of the reference signals received between the first time of receiving the MAC CE indication and the second time of receiving the subsequent communication is based at least in part on one or more of an indication, by the UE and after reception of the network node-predicted TCI state, of the number, an indication of support for predicting reception beams with the number of reference signal measurements, or a reference signal type of the reference signals.

In an twelfth aspect, alone or in combination with one or more of the first through eleventh aspects, process 900 includes receiving an indication of a resource for receiving the reference signals.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with techniques for predicting network node TCI states.

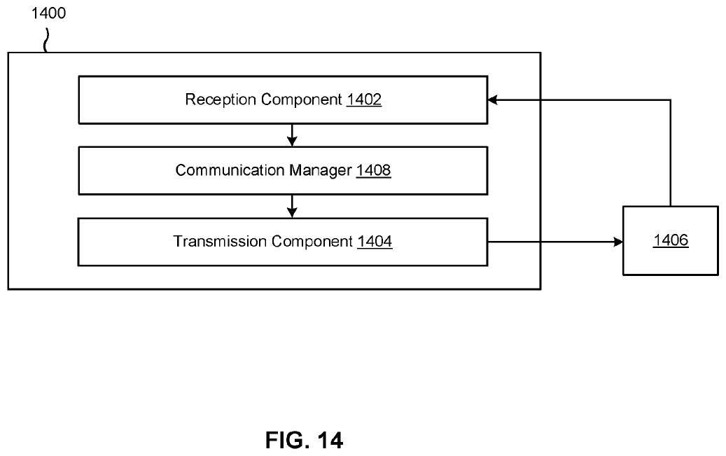

As shown in FIG. 10, in some aspects, process 1000 may include transmitting, to a UE, a MAC CE indication that activates a network node-predicted TCI state (block 1010). For example, the network node (e.g., using communication manager 150 and/or transmission component 1404, depicted in FIG. 14) may transmit, to a UE, a MAC CE indication that activates a network node-predicted TCI state, as described above.

As further shown in FIG. 10, in some aspects, process 1000 may include receiving an ACK associated with the MAC CE indication (block 1020). For example, the network node (e.g., using communication manager 150 and/or reception component 1402, depicted in FIG. 14) may receive an ACK associated with the MAC CE indication, as described above.

As further shown in FIG. 10, in some aspects, process 1000 may include transmitting DCI that indicates the network node-predicted TCI state for a subsequent communication, the DCI scheduling the subsequent communication at a scheduled time that is based at least in part on a threshold amount of time from the ACK or from the MAC CE indication (block 1030). For example, the network node (e.g., using communication manager 150 and/or transmission component 1404, depicted in FIG. 14) may transmit DCI that indicates the network node-predicted TCI state for a subsequent communication, the DCI scheduling the subsequent communication at a scheduled time that is based at least in part on a threshold amount of time from the ACK or from the MAC CE indication, as described above.

Process 1000 may include additional aspects, such as any single aspect or any combination of aspects described below and/or in connection with one or more other processes described elsewhere herein.

In a first aspect, process 1000 includes receiving, during a time period, an ACK associated with the MAC CE indication, wherein the DCI schedules the subsequent communication at a time that is based at least in part on a threshold amount of time from the time period, or wherein the DCI schedules the subsequent communication at a time that is based at least in part on the threshold amount of time from the MAC CE indication.

In a second aspect, alone or in combination with the first aspect, the threshold amount of time is based at least in part on one or more of an unknown TCI state switching latency, a UE capability for reception beam prediction, an indication, by the UE, of the threshold amount of time, or an indication, within the MAC CE indication, of the threshold amount of time.

In a third aspect, alone or in combination with one or more of the first and second aspects, the DCI schedules the subsequent communication at the scheduled time that is further based at least in part on being within an additional threshold amount of time from the ACK or from the MAC CE indication.

In a fourth aspect, alone or in combination with one or more of the first through third aspects, one or more of the first threshold amount of time or the second threshold amount of time is based at least in part on one or more of an unknown TCI state switching latency, a UE capability for reception beam prediction, an indication, by the UE, of one or more of the first threshold amount of time or the second threshold amount of time, or an indication, within the MAC CE indication, of one or more of the first threshold amount of time or the second threshold amount of time.

In a fifth aspect, alone or in combination with one or more of the first through fourth aspects, prior to reception of the MAC CE indication, the network node-predicted TCI state was not an active TCI state.

In a sixth aspect, alone or in combination with one or more of the first through fifth aspects, process 1000 includes transmitting the subsequent communication without transmitting reference signals associated with the network node-predicted TCI state between a first time of transmitting the MAC CE indication and a second time of transmitting the subsequent communication.

In a seventh aspect, alone or in combination with one or more of the first through sixth aspects, transmission of the subsequent communication without transmitting reference signals associated with the network node-predicted TCI state between the first time of transmitting the MAC CE indication and the second time of transmitting the subsequent communication is based at least in part on one or more of an indication, by the UE, of support for predicting reception beams without additional reference signal measurement, downlinking reference signals associated with the network node-predicted TCI state being associated with periodic or semi-persistent channel measurement resources, or an indication, by the UE and within feedback associated with the MAC CE, that the reference signals are not requested.

In an eighth aspect, alone or in combination with one or more of the first through seventh aspects, the indication within the feedback associated with the MAC CE is associated with the network node-predicted TCI state based at least in part on the network node-predicted TCI state being an only network node-predicted TCI state indicated in the MAC CE indication, or the indication within the feedback associated with the MAC CE being associated with all network node-predicted TCI state indicated in the MAC CE indication.

In a ninth aspect, alone or in combination with one or more of the first through eighth aspects, process 1000 includes transmitting the subsequent communication after transmitting reference signals associated with the network node-predicted TCI state between a first time of transmitting the MAC CE indication and a second time of transmitting the subsequent communication.

In a tenth aspect, alone or in combination with one or more of the first through ninth aspects, transmission of the subsequent communication after transmitting reference signals associated with the network node-predicted TCI state between the first time of transmitting the MAC CE indication and the second time of transmitting the subsequent communication is based at least in part on one or more of an indication, by the UE, of a request for reference signal measurement, a failure to indicate, by the UE, that the UE supports predicting reception beams without reference signal measurement, or the network node-predicted TCI state being an unknown TCI state.

In an eleventh aspect, alone or in combination with one or more of the first through tenth aspects, a number of the reference signals transmitted between the first time of transmitting the MAC CE indication and the second time of transmitting the subsequent communication is based at least in part on one or more of an indication, by the UE and after transmission of the network node-predicted TCI state, of the number, an indication of support for predicting reception beams with the number of reference signal measurements, or a reference signal type of the reference signals.

In an twelfth aspect, alone or in combination with one or more of the first through eleventh aspects, process 1000 includes transmitting an indication of a resource for receiving the reference signals.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with techniques for predicting network node TCI states.

As shown in FIG. 11, in some aspects, process 1100 may include transmitting an indication of support for receiving a DCI-based indication of a network node-predicted TCI state (block 1110). For example, the UE (e.g., using communication manager 140 and/or transmission component 1304, depicted in FIG. 13) may transmit an indication of support for receiving a DCI-based indication of a network node-predicted TCI state, as described above.

As further shown in FIG. 11, in some aspects, process 1100 may include receiving the DCI-based indication of the network node-predicted TCI state (block 1120). For example, the UE (e.g., using communication manager 140 and/or reception component 1302, depicted in FIG. 13) may receive the DCI-based indication of the network node-predicted TCI state, as described above.

Process 1100 may include additional aspects, such as any single aspect or any combination of aspects described below and/or in connection with one or more other processes described elsewhere herein.

In a first aspect, the indication of support includes an indication of a threshold amount of time between reception of the DCI-based indication and reception of a communication via the network node-predicted TCI state.

In a second aspect, alone or in combination with the first aspect, the threshold amount of time is based at least in part on a capability of the UE for configuring a reception beam for the network node-predicted TCI state.

In a third aspect, alone or in combination with one or more of the first and second aspects, process 1100 includes transmitting an indication of the capability of the UE for configuring a reception beam for the network node-predicted TCI state reported to a network node associated with the network node-predicted TCI state.

In a fourth aspect, alone or in combination with one or more of the first through third aspects, the threshold amount of time is based at least in part on one or more of a subcarrier spacing associated with the communication, or whether the network node-predicted TCI state is unknown.

In a fifth aspect, alone or in combination with one or more of the first through fourth aspects, process 1100 includes receiving configuration information that enables DCI-based indications of network node-predicted TCI states.

In a sixth aspect, alone or in combination with one or more of the first through fifth aspects, process 1100 includes one or more of receiving an indication that unknown TCI states are network node-predicted TCI states, receiving RRC signaling that indicates that the network node-predicted TCI state is network node-predicted, receiving a MAC CE that indicates that the network node-predicted TCI state is network node-predicted, or receiving, within the DCI-based indication, an indication that the network node-predicted TCI state is network node-predicted.

In a seventh aspect, alone or in combination with one or more of the first through sixth aspects, the MAC CE comprises a MAC CE configured for activating only network node-predicted TCI states.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with techniques for predicting network node TCI states.

As shown in FIG. 12, in some aspects, process 1200 may include receiving, from a UE, an indication of support for receiving a DCI-based indication of a network node-predicted TCI state (block 1210). For example, the base station (e.g., using communication manager 150 and/or reception component 1402, depicted in FIG. 14) may receive, from a UE, an indication of support for receiving a DCI-based indication of a network node-predicted TCI state, as described above.

As further shown in FIG. 12, in some aspects, process 1200 may include transmitting the DCI-based indication of the network node-predicted TCI state (block 1220). For example, the base station (e.g., using communication manager 150 and/or transmission component 1404, depicted in FIG. 14) may transmit the DCI-based indication of the network node-predicted TCI state, as described above.

Process 1200 may include additional aspects, such as any single aspect or any combination of aspects described below and/or in connection with one or more other processes described elsewhere herein.

In a first aspect, the indication of support includes an indication of a threshold amount of time between reception of the DCI-based indication and reception of a communication via the network node-predicted TCI state.

In a second aspect, alone or in combination with the first aspect, the threshold amount of time is based at least in part on a capability of the UE for configuring a reception beam for the network node-predicted TCI state.

In a third aspect, alone or in combination with one or more of the first and second aspects, process 1200 includes receiving an indication of the capability of the UE for configuring a reception beam for the network node-predicted TCI state reported to a network node associated with the network node-predicted TCI state.

In a fourth aspect, alone or in combination with one or more of the first through third aspects, the threshold amount of time is based at least in part on one or more of a subcarrier spacing associated with the communication, or whether the network node-predicted TCI state is unknown.

In a fifth aspect, alone or in combination with one or more of the first through fourth aspects, process 1200 includes transmitting configuration information that enables DCI-based indications of network node-predicted TCI states.

In a sixth aspect, alone or in combination with one or more of the first through fifth aspects, process 1200 includes one or more of transmitting an indication that unknown TCI states are network node-predicted TCI states, transmitting RRC signaling that indicates that the network node-predicted TCI state is network node-predicted, transmitting a MAC CE that indicates that the network node-predicted TCI state is network node-predicted, or transmitting, within the DCI-based indication, an indication that the network node-predicted TCI state is network node-predicted.

In a seventh aspect, alone or in combination with one or more of the first through sixth aspects, the MAC CE comprises a MAC CE configured for activating only network node-predicted TCI states.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308 (e.g., the communication manager 140).

In some aspects, the apparatus 1300 may be configured to perform one or more operations described herein in connection with FIGS. 6-8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive a MAC CE indication that activates a network node-predicted TCI state. The transmission component 1304 may transmit an ACK associated with the MAC CE indication. The reception component 1302 may receive DCI that indicates the network node-predicted TCI state for a subsequent communication, the DCI scheduling the subsequent communication at a scheduled time that is based at least in part on a threshold amount of time from the ACK or from the MAC CE indication.

The transmission component 1304 may transmit, during a time period, an ACK associated with the MAC CE indication wherein the DCI schedules the subsequent communication at a time that is based at least in part on a threshold amount of time from the time period, or wherein the DCI schedules the subsequent communication at a time that is based at least in part on the threshold amount of time from the MAC CE indication.

The reception component 1302 may receive the subsequent communication without receiving reference signals associated with the network node-predicted TCI state between a first time of receiving the MAC CE indication and a second time of receiving the subsequent communication.

The reception component 1302 may receive the subsequent communication after receiving reference signals associated with the network node-predicted TCI state between a first time of receiving the MAC CE indication and a second time of receiving the subsequent communication.

The reception component 1302 may receive an indication of a resource for receiving the reference signals.

The transmission component 1304 may transmit an indication of support for receiving a DCI-based indication of a network node-predicted TCI state. The reception component 1302 may receive the DCI-based indication of the network node-predicted TCI state.

The transmission component 1304 may transmit an indication of the capability of the UE for configuring a reception beam for the network node-predicted TCI state reported to a network node associated with the network node-predicted TCI state.

The reception component 1302 may receive configuration information that enables DCI-based indications of network node-predicted TCI states.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a communication manager 1408 (e.g., the communication manager 150).

In some aspects, the apparatus 1400 may be configured to perform one or more operations described herein in connection with FIGS. 6-8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The transmission component 1404 may transmit, to a UE, a MAC CE indication that activates a network node-predicted TCI state. The reception component 1402 may receive an ACK associated with the MAC CE indication. The transmission component 1404 may transmit DCI that indicates the network node-predicted TCI state for a subsequent communication, the DCI scheduling the subsequent communication at a scheduled time that is based at least in part on a threshold amount of time from the ACK or from the MAC CE indication.

The reception component 1402 may receive, during a time period, an ACK associated with the MAC CE indication wherein the DCI schedules the subsequent communication at a time that is based at least in part on a threshold amount of time from the time period, or wherein the DCI schedules the subsequent communication at a time that is based at least in part on the threshold amount of time from the MAC CE indication.

The transmission component 1404 may transmit the subsequent communication without transmitting reference signals associated with the network node-predicted TCI state between a first time of transmitting the MAC CE indication and a second time of transmitting the subsequent communication.

The transmission component 1404 may transmit the subsequent communication after transmitting reference signals associated with the network node-predicted TCI state between a first time of transmitting the MAC CE indication and a second time of transmitting the subsequent communication.

The transmission component 1404 may transmit an indication of a resource for receiving the reference signals.

The reception component 1402 may receive, from a UE, an indication of support for receiving a DCI-based indication of a network node-predicted TCI state. The transmission component 1404 may transmit the DCI-based indication of the network node-predicted TCI state.

The reception component 1402 may receive an indication of the capability of the UE for configuring a reception beam for the network node-predicted TCI state reported to a network node associated with the network node-predicted TCI state.

The transmission component 1404 may transmit configuration information that enables DCI-based indications of network node-predicted TCI states.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving a medium access control (MAC) control element (CE) indication that activates a network node-predicted transmission configuration indicator (TCI) state; transmitting an acknowledgment (ACK) associated with the MAC CE indication; and receiving downlink control information (DCI) that indicates the network node-predicted TCI state for a subsequent communication, the DCI scheduling the subsequent communication at a scheduled time that is based at least in part on a threshold amount of time from the ACK or from the MAC CE indication.

Aspect 2: The method of Aspect 1, further comprising: transmitting, during a time period, an ACK associated with the MAC CE indication, wherein the DCI schedules the subsequent communication at a time that is based at least in part on a threshold amount of time from the time period, or wherein the DCI schedules the subsequent communication at a time that is based at least in part on the threshold amount of time from the MAC CE indication.

Aspect 3: The method of Aspect 2, wherein the threshold amount of time is based at least in part on one or more of: an unknown TCI state switching latency, a UE capability for reception beam prediction, an indication, by the UE, of the threshold amount of time, or an indication, within the MAC CE indication, of the threshold amount of time.

Aspect 4: The method of Aspect 1, wherein the DCI schedules the subsequent communication at the scheduled time that is further based at least in part on being within an additional threshold amount of time from the ACK or from the MAC CE indication.

Aspect 5: The method of Aspect 4, wherein one or more of the first threshold amount of time or the second threshold amount of time is based at least in part on one or more of: an unknown TCI state switching latency, a UE capability for reception beam prediction, an indication, by the UE, of one or more of the first threshold amount of time or the second threshold amount of time, or an indication, within the MAC CE indication, of one or more of the first threshold amount of time or the second threshold amount of time.

Aspect 6: The method of any of any of Aspects 1-5, wherein, prior to reception of the MAC CE indication, the network node-predicted TCI state was not an active TCI state.

Aspect 7: The method of any of any of Aspects 1-6, further comprising: receiving the subsequent communication without receiving reference signals associated with the network node-predicted TCI state between a first time of receiving the MAC CE indication and a second time of receiving the subsequent communication.

Aspect 8: The method of Aspect 7, wherein reception of the subsequent communication without receiving reference signals associated with the network node-predicted TCI state between the first time of receiving the MAC CE indication and the second time of receiving the subsequent communication is based at least in part on one or more of: an indication, by the UE, of support for predicting reception beams without additional reference signal measurement, downlink reference signals associated with the network node-predicted TCI state being associated with periodic or semi-persistent channel measurement resources, or an indication, by the UE and within feedback associated with the MAC CE, that the reference signals are not requested.

Aspect 9: The method of Aspect 8, wherein the indication within the feedback associated with the MAC CE is associated with the network node-predicted TCI state based at least in part on: the network node-predicted TCI state being an only network node-predicted TCI state indicated in the MAC CE indication, or the indication within the feedback associated with the MAC CE being associated with all network node-predicted TCI state indicated in the MAC CE indication.

Aspect 10: The method of any of any of Aspects 1-9, further comprising: receiving the subsequent communication after receiving reference signals associated with the network node-predicted TCI state between a first time of receiving the MAC CE indication and a second time of receiving the subsequent communication.

Aspect 11: The method of Aspect 10, wherein reception of the subsequent communication after receiving reference signals associated with the network node-predicted TCI state between the first time of receiving the MAC CE indication and the second time of receiving the subsequent communication is based at least in part on one or more of: an indication, by the UE, of a request for reference signal measurement, a failure to indicate, by the UE, that the UE supports predicting reception beams without reference signal measurement, or the network node-predicted TCI state being an unknown TCI state.

Aspect 12: The method of any of Aspects 10-11, wherein a number of the reference signals received between the first time of receiving the MAC CE indication and the second time of receiving the subsequent communication is based at least in part on one or more of: an indication, by the UE and after reception of the network node-predicted TCI state, of the number, an indication of support for predicting reception beams with the number of reference signal measurements, or a reference signal type of the reference signals.

Aspect 13: The method of any of Aspects 10-12, further comprising: receiving an indication of a resource for receiving the reference signals.

Aspect 14: A method of wireless communication performed by a network node, comprising: transmitting, to a user equipment (UE), a medium access control (MAC) control element (CE) indication that activates a network node-predicted transmission configuration indicator (TCI) state; receiving an acknowledgment (ACK) associated with the MAC CE indication; and transmitting downlink control information (DCI) that indicates the network node-predicted TCI state for a subsequent communication, the DCI scheduling the subsequent communication at a scheduled time that is based at least in part on a threshold amount of time from the ACK or from the MAC CE indication.

Aspect 15: The method of Aspect 14, further comprising: receiving, during a time period, an ACK associated with the MAC CE indication, wherein the DCI schedules the subsequent communication at a time that is based at least in part on a threshold amount of time from the time period, or wherein the DCI schedules the subsequent communication at a time that is based at least in part on the threshold amount of time from the MAC CE indication.

Aspect 16: The method of Aspect 15, wherein the threshold amount of time is based at least in part on one or more of: an unknown TCI state switching latency, a UE capability for reception beam prediction, an indication, by the UE, of the threshold amount of time, or an indication, within the MAC CE indication, of the threshold amount of time.

Aspect 17: The method of Aspect 14, wherein the DCI schedules the subsequent communication at the scheduled time that is further based at least in part on being within an additional threshold amount of time from the ACK or from the MAC CE indication.

Aspect 18: The method of Aspect 17, wherein one or more of the first threshold amount of time or the second threshold amount of time is based at least in part on one or more of: an unknown TCI state switching latency, a UE capability for reception beam prediction, an indication, by the UE, of one or more of the first threshold amount of time or the second threshold amount of time, or an indication, within the MAC CE indication, of one or more of the first threshold amount of time or the second threshold amount of time.

Aspect 19: The method of any of Aspects 14-18, wherein, prior to reception of the MAC CE indication, the network node-predicted TCI state was not an active TCI state.

Aspect 20: The method of any of Aspects 14-19, further comprising: transmitting the subsequent communication without transmitting reference signals associated with the network node-predicted TCI state between a first time of transmitting the MAC CE indication and a second time of transmitting the subsequent communication.

Aspect 21: The method of Aspect 20, wherein transmission of the subsequent communication without transmitting reference signals associated with the network node-predicted TCI state between the first time of transmitting the MAC CE indication and the second time of transmitting the subsequent communication is based at least in part on one or more of: an indication, by the UE, of support for predicting reception beams without additional reference signal measurement, downlink reference signals associated with the network node-predicted TCI state being associated with periodic or semi-persistent channel measurement resources, or an indication, by the UE and within feedback associated with the MAC CE, that the reference signals are not requested.

Aspect 22: The method of Aspect 21, wherein the indication within the feedback associated with the MAC CE is associated with the network node-predicted TCI state based at least in part on: the network node-predicted TCI state being an only network node-predicted TCI state indicated in the MAC CE indication, or the indication within the feedback associated with the MAC CE being associated with all network node-predicted TCI state indicated in the MAC CE indication.

Aspect 23: The method of any of Aspects 14-22, further comprising: transmitting the subsequent communication after transmitting reference signals associated with the network node-predicted TCI state between a first time of transmitting the MAC CE indication and a second time of transmitting the subsequent communication.

Aspect 24: The method of Aspect 23, wherein transmission of the subsequent communication after transmitting reference signals associated with the network node-predicted TCI state between the first time of transmitting the MAC CE indication and the second time of transmitting the subsequent communication is based at least in part on one or more of: an indication, by the UE, of a request for reference signal measurement, a failure to indicate, by the UE, that the UE supports predicting reception beams without reference signal measurement, or the network node-predicted TCI state being an unknown TCI state.

Aspect 25: The method of any of Aspects 23-24, wherein a number of the reference signals transmitted between the first time of transmitting the MAC CE indication and the second time of transmitting the subsequent communication is based at least in part on one or more of: an indication, by the UE and after transmission of the network node-predicted TCI state, of the number, an indication of support for predicting reception beams with the number of reference signal measurements, or a reference signal type of the reference signals.

Aspect 26: The method of any of Aspects 23-25, further comprising: transmitting an indication of a resource for receiving the reference signals.

Aspect 27: A method of wireless communication performed by a user equipment (UE), comprising: transmitting an indication of support for receiving a downlink control information (DCI)-based indication of a network node-predicted transmission configuration indicator (TCI) state; and receiving the DCI-based indication of the network node-predicted TCI state.

Aspect 28: The method of Aspect 27, wherein the indication of support includes an indication of a threshold amount of time between reception of the DCI-based indication and reception of a communication via the network node-predicted TCI state.

Aspect 29: The method of Aspect 28, wherein the threshold amount of time is based at least in part on a capability of the UE for configuring a reception beam for the network node-predicted TCI state.

Aspect 30: The method of Aspect 29, further comprising: transmitting an indication of the capability of the UE for configuring a reception beam for the network node-predicted TCI state reported to a network node associated with the network node-predicted TCI state.

Aspect 31: The method of any of Aspects 28-30, wherein the threshold amount of time is based at least in part on one or more of: a subcarrier spacing associated with the communication, or whether the network node-predicted TCI state is unknown.

Aspect 32: The method of any of Aspects 28-31, further comprising: receiving configuration information that enables DCI-based indications of network node-predicted TCI states.

Aspect 33: The method of any of Aspects 28-32, further comprising one or more of: receiving an indication that unknown TCI states are network node-predicted TCI states; receiving radio resource control (RRC) signaling that indicates that the network node-predicted TCI state is network node-predicted; receiving a medium access control (MAC) control element (CE) that indicates that the network node-predicted TCI state is network node-predicted, or receiving, within the DCI-based indication, an indication that the network node-predicted TCI state is network node-predicted.

Aspect 34: The method of Aspect 33, wherein the MAC CE comprises a MAC CE configured for activating only network node-predicted TCI states.

Aspect 35: A method of wireless communication performed by a base station, comprising: receiving, from a user equipment (UE), an indication of support for receiving a downlink control information (DCI)-based indication of a network node-predicted transmission configuration indicator (TCI) state; and transmitting the DCI-based indication of the network node-predicted TCI state.

Aspect 36: The method of Aspect 35, wherein the indication of support includes an indication of a threshold amount of time between reception of the DCI-based indication and reception of a communication via the network node-predicted TCI state.

Aspect 37: The method of Aspect 36, wherein the threshold amount of time is based at least in part on a capability of the UE for configuring a reception beam for the network node-predicted TCI state.

Aspect 38: The method of Aspect 37, further comprising: receiving an indication of the capability of the UE for configuring a reception beam for the network node-predicted TCI state reported to a network node associated with the network node-predicted TCI state.

Aspect 39: The method of any of Aspects 36-38, wherein the threshold amount of time is based at least in part on one or more of: a subcarrier spacing associated with the communication, or whether the network node-predicted TCI state is unknown.

Aspect 40: The method of any of Aspects 35-39, further comprising: transmitting configuration information that enables DCI-based indications of network node-predicted TCI states.

Aspect 41: The method of any of Aspects 35-40, further comprising one or more of: transmitting an indication that unknown TCI states are network node-predicted TCI states; transmitting radio resource control (RRC) signaling that indicates that the network node-predicted TCI state is network node-predicted; transmitting a medium access control (MAC) control element (CE) that indicates that the network node-predicted TCI state is network node-predicted, or transmitting, within the DCI-based indication, an indication that the network node-predicted TCI state is network node-predicted.

Aspect 42: The method of Aspect 41, wherein the MAC CE comprises a MAC CE configured for activating only network node-predicted TCI states.

Aspect 43: An apparatus for wireless communication at a device, comprising a processor; memory coupled with the processor; and instructions stored in the memory and executable by the processor to cause the apparatus to perform the method of one or more of Aspects 1-42.

Aspect 44: A device for wireless communication, comprising a memory and one or more processors coupled to the memory, the one or more processors configured to perform the method of one or more of Aspects 1-42.

Aspect 45: An apparatus for wireless communication, comprising at least one means for performing the method of one or more of Aspects 1-42.

Aspect 46: A non-transitory computer-readable medium storing code for wireless communication, the code comprising instructions executable by a processor to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving a medium access control (MAC) control element (CE) indication that activates a network node-predicted transmission configuration indicator (TCI) state;
transmitting an acknowledgment (ACK) associated with the MAC CE indication; and
receiving downlink control information (DCI) that indicates the network node-predicted TCI state for a subsequent communication, the DCI scheduling the subsequent communication at a scheduled time that is based at least in part on a threshold amount of time from the ACK or from the MAC CE indication.

2. The method of claim 1, further comprising:
transmitting, during a time period, the ACK associated with the MAC CE indication,
wherein the DCI schedules the subsequent communication at a time that is based at least in part on a threshold amount of time from the time period, or
wherein the DCI schedules the subsequent communication at a time that is based at least in part on the threshold amount of time from the MAC CE indication.

3. The method of claim 2, wherein the threshold amount of time is based at least in part on one or more of:
an unknown TCI state switching latency,
a UE capability for reception beam prediction,
an indication, by the UE, of the threshold amount of time, or
an indication, within the MAC CE indication, of the threshold amount of time.

4. The method of claim 1, wherein the DCI schedules the subsequent communication at the scheduled time that is further based at least in part on being within an additional threshold amount of time from the ACK or from the MAC CE indication.

5. The method of claim 4, wherein one or more of the threshold amount of time or the additional threshold amount of time is based at least in part on one or more of:
an unknown TCI state switching latency,
a UE capability for reception beam prediction,
an indication, by the UE, of one or more of the first threshold amount of time or the second threshold amount of time, or
an indication, within the MAC CE indication, of one or more of the threshold amount of time or the additional threshold amount of time.

6. The method of claim 1, wherein, prior to reception of the MAC CE indication, the network node-predicted TCI state was not an active TCI state.

7. The method of claim 1, further comprising:
receiving the subsequent communication without receiving reference signals associated with the network node-predicted TCI state between a first time of receiving the MAC CE indication and a second time of receiving the subsequent communication.

8. The method of claim 7, wherein reception of the subsequent communication without receiving reference signals associated with the network node-predicted TCI state between the first time of receiving the MAC CE indication and the second time of receiving the subsequent communication is based at least in part on one or more of:
an indication, by the UE, of support for predicting reception beams without additional reference signal measurement,
downlink reference signals associated with the network node-predicted TCI state being associated with periodic or semi-persistent channel measurement resources, or
an indication, by the UE and within feedback associated with the MAC CE, that the reference signals are not requested.

9. The method of claim 8, wherein the indication within the feedback associated with the MAC CE is associated with the network node-predicted TCI state based at least in part on:
the network node-predicted TCI state being an only network node-predicted TCI state indicated in the MAC CE indication, or
the indication within the feedback associated with the MAC CE being associated with all network node-predicted TCI state indicated in the MAC CE indication.

10. The method of claim 1, further comprising:
receiving the subsequent communication after receiving reference signals associated with the network node-predicted TCI state between a first time of receiving the MAC CE indication and a second time of receiving the subsequent communication.

11. The method of claim 10, wherein reception of the subsequent communication after receiving reference signals associated with the network node-predicted TCI state between the first time of receiving the MAC CE indication and the second time of receiving the subsequent communication is based at least in part on one or more of:
an indication, by the UE, of a request for reference signal measurement,
a failure to indicate, by the UE, that the UE supports predicting reception beams without reference signal measurement, or
the network node-predicted TCI state being an unknown TCI state.

12. The method of claim 10, wherein a number of the reference signals received between the first time of receiving the MAC CE indication and the second time of receiving the subsequent communication is based at least in part on one or more of:
an indication, by the UE and after reception of the network node-predicted TCI state, of the number,
an indication of support for predicting reception beams with the number of reference signal measurements, or
a reference signal type of the reference signals.

13. The method of claim 10, further comprising:
receiving an indication of a resource for receiving the reference signals.

14. A method of wireless communication performed by a network node, comprising:
transmitting, to a user equipment (UE), a medium access control (MAC) control element (CE) indication that activates a network node-predicted transmission configuration indicator (TCI) state;
receiving an acknowledgment (ACK) associated with the MAC CE indication; and
transmitting downlink control information (DCI) that indicates the network node-predicted TCI state for a subsequent communication, the DCI scheduling the subsequent communication at a scheduled time that is based at least in part on a threshold amount of time from the ACK or from the MAC CE indication.

15. The method of claim 14, further comprising:
receiving, during a time period, the ACK associated with the MAC CE indication,
wherein the DCI schedules the subsequent communication at a time that is based at least in part on a threshold amount of time from the time period, or
wherein the DCI schedules the subsequent communication at a time that is based at least in part on the threshold amount of time from the MAC CE indication.

16. The method of claim 15, wherein the threshold amount of time is based at least in part on one or more of:
an unknown TCI state switching latency,
a UE capability for reception beam prediction,
an indication, by the UE, of the threshold amount of time, or
an indication, within the MAC CE indication, of the threshold amount of time.

17. The method of claim 14, wherein the DCI schedules the subsequent communication at the scheduled time that is further based at least in part on being within an additional threshold amount of time from the ACK or from the MAC CE indication.

18. The method of claim 17, wherein one or more of the threshold amount of time or the additional threshold amount of time is based at least in part on one or more of:
an unknown TCI state switching latency,
a UE capability for reception beam prediction,
an indication, by the UE, of one or more of the first threshold amount of time or the second threshold amount of time, or
an indication, within the MAC CE indication, of one or more of the first threshold amount of time or the additional threshold amount of time.

19. The method of claim 14, wherein, prior to reception of the MAC CE indication, the network node-predicted TCI state was not an active TCI state.

20. The method of claim 14, further comprising:
transmitting the subsequent communication without transmitting reference signals associated with the network node-predicted TCI state between a first time of transmitting the MAC CE indication and a second time of transmitting the subsequent communication.

21. The method of claim 20, wherein transmission of the subsequent communication without transmitting reference signals associated with the network node-predicted TCI state between the first time of transmitting the MAC CE indication and the second time of transmitting the subsequent communication is based at least in part on one or more of:
an indication, by the UE, of support for predicting reception beams without additional reference signal measurement,
downlink reference signals associated with the network node-predicted TCI state being associated with periodic or semi-persistent channel measurement resources, or
an indication, by the UE and within feedback associated with the MAC CE, that the reference signals are not requested.

22. The method of claim 21, wherein the indication within the feedback associated with the MAC CE is associated with the network node-predicted TCI state based at least in part on:
the network node-predicted TCI state being an only network node-predicted TCI state indicated in the MAC CE indication, or
the indication within the feedback associated with the MAC CE being associated with all network node-predicted TCI state indicated in the MAC CE indication.

23. The method of claim 14, further comprising:
transmitting the subsequent communication after transmitting reference signals associated with the network node-predicted TCI state between a first time of transmitting the MAC CE indication and a second time of transmitting the subsequent communication.

24. The method of claim 23, wherein transmission of the subsequent communication after transmitting reference signals associated with the network node-predicted TCI state between the first time of transmitting the MAC CE indication and the second time of transmitting the subsequent communication is based at least in part on one or more of:
an indication, by the UE, of a request for reference signal measurement,
a failure to indicate, by the UE, that the UE supports predicting reception beams without reference signal measurement, or
the network node-predicted TCI state being an unknown TCI state.

25. The method of claim 23, wherein a number of the reference signals transmitted between the first time of transmitting the MAC CE indication and the second time of transmitting the subsequent communication is based at least in part on one or more of:
an indication, by the UE and after transmission of the network node-predicted TCI state, of the number,
an indication of support for predicting reception beams with the number of reference signal measurements, or
a reference signal type of the reference signals.

26. The method of claim 23, further comprising:
transmitting an indication of a resource for receiving the reference signals.

27. A user equipment (UE) for wireless communication, comprising:
a memory; and
one or more processors, coupled to the memory, configured to:
receive a medium access control (MAC) control element (CE) indication that activates a network node-predicted transmission configuration indicator (TCI) state;
transmit an acknowledgment (ACK) associated with the MAC CE indication; and
receive downlink control information (DCI) that indicates the network node-predicted TCI state for a subsequent communication, the DCI scheduling the subsequent communication at a scheduled time that is based at least in part on a threshold amount of time from the ACK or from the MAC CE indication.

28. The method of claim 27, wherein the one or more processors are further configured to:
transmit, during a time period, the ACK associated with the MAC CE indication,
wherein the DCI schedules the subsequent communication at a time that is based at least in part on a threshold amount of time from the time period, or
wherein the DCI schedules the subsequent communication at a time that is based at least in part on the threshold amount of time from the MAC CE indication.

29. A network node for wireless communication, comprising:
a memory; and
one or more processors, coupled to the memory, configured to:
transmit, to a user equipment (UE), a medium access control (MAC) control element (CE) indication that activates a network node-predicted transmission configuration indicator (TCI) state;
receive an acknowledgment (ACK) associated with the MAC CE indication; and
transmit downlink control information (DCI) that indicates the network node-predicted TCI state for a subsequent communication, the DCI scheduling the subsequent communication at a scheduled time that is based at least in part on a threshold amount of time from the ACK or from the MAC CE indication.

30. The method of claim 29, wherein the one or more processors are further configured to:
transmit, during a time period, the ACK associated with the MAC CE indication,
wherein the DCI schedules the subsequent communication at a time that is based at least in part on a threshold amount of time from the time period, or
wherein the DCI schedules the subsequent communication at a time that is based at least in part on the threshold amount of time from the MAC CE indication.
